(19) United States
(12) Patent Application Publication
(10) Pub. No.: US 2026/0065064 A1
(43) Pub. Date: Mar. 5, 2026

(54) END-TO-END TASK-ORIENTED DIALOGUE SYSTEM WITH FEW-SHOT LEARNING

(71) Applicant: VIETTEL GROUP, Ha Noi City (VN)

(72) Inventors: KHAC HOAI NAM BUI, Ha Noi City (VN); QUANG CHIEU NGUYEN, Vu Thu District (VN); THANH DO NGUYEN, Ha Noi City (VN)

(73) Assignee: VIETTEL GROUP, Ha Noi City (VN)

(21) Appl. No.: 19/022,592

(22) Filed: Jan. 15, 2025

(30) Foreign Application Priority Data
Aug. 27, 2024 (VN) 1-2024-06444

(51) Int. Cl. G06N 3/0895; G06F 40/40

(52) U.S. Cl. CPC G06N 3/0895; G06F 40/40

(57) ABSTRACT

The invention proposes a novel method for developing a TOD model by representing input data as function calls and utilizing LLM as the foundational model to train multi-tasks via finetuning LLM with instruction. Furthermore, to implement the proposed model on LLMs with moderate sizes (fewer than 10 billion parameters), the invention also presents a finetuning LLM method to enhance the capability of these LLMs in terms of handling function-calling tasks. Finally, an effective training strategy with customized loss functions for each specific task is presented to optimize the training process. Experimental results on the standard MultiWOZ 2.2 dataset demonstrate the superior performance of the proposed method compared to existing approaches in this field of research.

### BACKGROUND

### 1. Technical Field

The invention relates to an efficient method of developing end-to-end task-oriented dialogue models (TOD) using few-shot learning. Specifically, the technique aims to get better performance for TOD systems that require less sample data for training, thus improving the capabilities of scalability and extensibility to develop real-world applications in this research field.

### 2. Introduction

AI Virtual assistant, or Conversational AI, can be divided into three categories: Open-domain dialogue (OOD), Conversational Information Seeking System (CIS), and Task-Oriented dialogue (TOD). In the case of OOD, for instance, ChatGPT focuses on open-domain dialogue, which aims to provide users with useful information across various topics without a specific goal orientation. In contrast, CIS systems engage in information-seeking to fulfill the information retrieval needs based on the request of the users. Meanwhile, TOD systems are designed to perform specific task-oriented functions, assisting users in achieving defined goals, such as booking hotels, reserving restaurants, creating bank accounts, etc. With the increasing demand for developing TOD models for business applications, both academic research and industrial development are paying more attention to this area, especially with the emergence of pre-trained large language models (LLMs). This invention introduces an efficient training method for TOD models in terms of scalability and extensibility.

Specifically, one of the major challenges for TOD models in real-world applications is in line with the scalability capabilities of a new domain. In particular, a general pipeline of TOD models requires multi-task training on three Natural Language Processing (NLP) tasks, such as Natural Language Understanding (NLU), Dialogue State Tracking (DST), and Natural Language Generation (NLG), which require meticulous labeling and incurs significant costs regarding data annotation. Recently, the emergence of modern LLMs such as GPT-3.5 and GPT-4, which contain hundreds of billions of parameters, have revolutionized the field of NLP tasks, in terms of executing multi-tasks via leveraging prompt engineering. This approach involves embedding all domain-related information into prompts to sequentially perform the required tasks for TOD models, thereby mitigating the need for labeling and model training. Nonetheless, this approach still faces significant limitations, such as the reliance on excessively large models, difficulty in control, and particularly, challenges in handling domains with complex scenarios.

In this regard, based on this observation, this invention presents a few-shot learning learning approach for TOD models, leveraging the power of LLM technologies. In particular, the method in this invention utilizes foundational LLMs as the backbone with a size of fewer than 10 billion parameters, offering controllable and operational convenience, thereby ensuring highly practical applications.

### BRIEF DESCRIPTION OF THE DRAWINGS

FIG. 1 illustrates an overview of the task-oriented dialogue virtual assistant model proposed in the invention (step 1);

FIG. 2 illustrates the process of fine-tuning the LLM for the function-calling task with dialogue data (step 2);

FIG. 3 shows an example of a training sample used for the raining process, which includes five role components: System, User, Function, Observation, and Assistant. (step 3).

### DETAILED DESCRIPTION

The method of this invention addresses two key challenges: i) Proposing a new TOD architecture to enable limited training samples while maintaining the performance, and ii) Developing an efficient training method to utilize moderately sized LLMs (fewer than 10 billion parameters) for model training. Specifically, the method first represents the domain-specific knowledge as separate function domains. These function domains are then utilized as inputs for tasks proposed in the invention, including function selection, function completion, and response generation. For multitask training on function-related tasks, a fine-tuning instruction method is adopted, which involves designing loss function strategies to ensure the model achieves optimal performance.

To accomplish these objectives, the invention outlines the following steps:
Step 1: Proposing an LLM-powered end-to-end TOD pipeline;
Step 2: Fine-tuning instruction LLM for multi-task learning of function-related tasks;
Step 3: Proposing efficient training strategies.

### DETAILED DESCRIPTION OF THE INVENTION

The Details of These Steps Are As Follows:

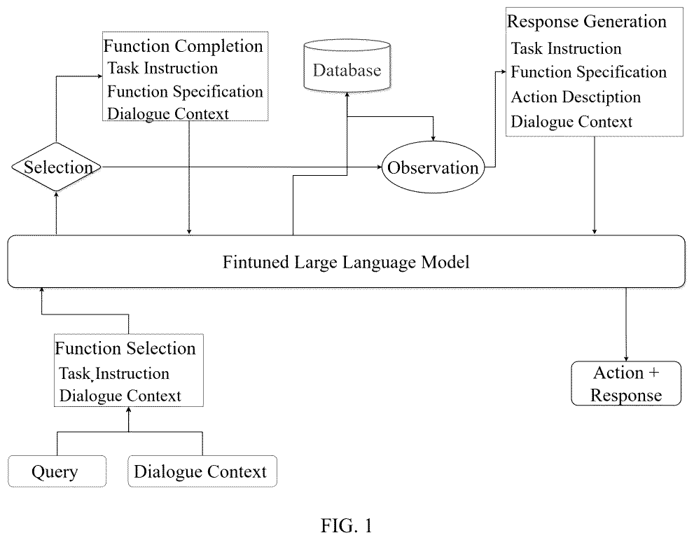

Step 1: Proposing an LLM-powered end-to-end TOD pipeline. At this step, the focus is on proposing a new architecture for the TOD model using the concept of function representation. Specifically, a traditional TOD model includes three sequential NLP tasks: i) NLU task: identifying the domain of the user query; ii) DST task: combining the query with the dialogue context to determine the current state, including intent-entity pairs for querying the database; iii) NLG task: using the database results to generate responses, providing appropriate actions and replies to the user. To enable a TOD model to operate using few-shot learning with an LLM as the backbone, this invention proposes a novel architecture that standardizes the above tasks into a function-calling paradigm. The proposed model architecture is detailed in FIG. 1 of the invention. Specifically, the architecture comprises three main task components: i) Function Selection: In this task, each function corresponds to a specific domain (e.g., restaurants, taxis, hotels, trains, etc.). The argument pairs for each function consist of predefined entities and their values within the domain. Given the user query and dialogue history as input, this task identifies the domain topic referenced by the current query; ii) Function Completion: Using the identified domain from the previous task, along with the user query and dialogue history, this task determines the argument pairs (entity-value pairs) to query the database within the specific domain. iii) Generate Response: Based on the database results, this task is designed to determine the appropriate action and generate a suitable response for the input query.

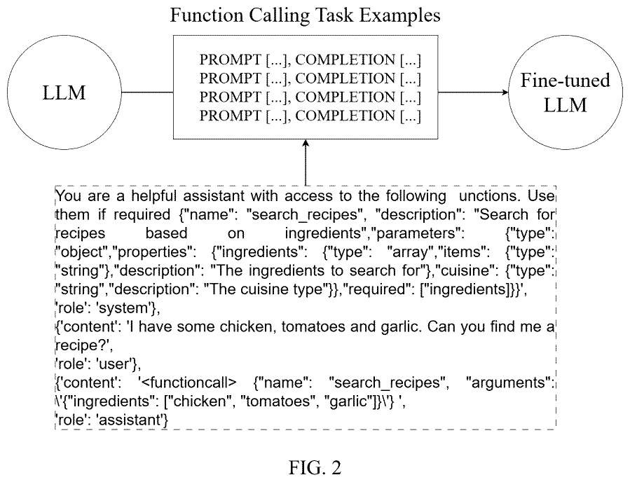

Step 2: Fine-tuning instruction LLM for multi-task learning of function-related tasks. A critical requirement for executing the method in this invention is that the LLM must be capable of handling function calls with dialogue data. In this regard, in order to equip and integrate the capability of handling function calling with dialogue data into LLMs with a size model is fewer than 10 billion parameters, this invention proposes a fine-tuning method (finetune instruction) using existing dialogue datasets. Specifically, the invention utilizes a dataset comprising 7,000 conversational samples across 36 different domains to perform fine-tuning at this stage. In particular, the finetuning instruction process of this step is illustrated in FIG. 2 of this invention. After this step, a fine-tuned LLM, which is able to effectively perform function-calling tasks, is then utilized to train the proposed TOD model in this invention.

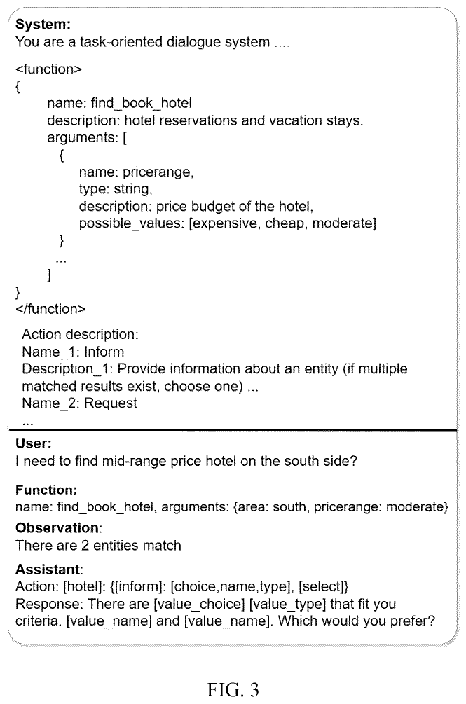

Step 3: Proposing efficient training strategies. The main objective of this invention is to propose a method for developing end-to-end TOD models using LLMs. Accordingly, the tasks proposed for the TOD model in this invention, including function selection, function completion, and response generation, are represented as multi-task training via fine-tuning of LLMs. FIG. 3 of this invention illustrates an example of a standardized training sample used for the training process. Specifically, a standardized training sample includes five role components: System, User, Function, Observation, and Assistant. According, the System role provides general instructions for the virtual assistant system, the User and Assistant roles describe the user query and the assistant's response, respectively, the Function role includes descriptions of the domain and predefined arguments within the specified domain, and the State role describes the state output returned by the system after querying the database. Furthermore, in this step, unlike the general loss function used in typical LLM fine-tuning processes, the invention proposes task-specific loss functions for each task, which are sequentially described as follows: i) for the function selection task, the loss function is computed based on the content of State role; ii) for the function completion task, the loss function is computed based on the content of the Function role, including the extracted entity-argument pairs (entity-value pairs); iii) for the response generation task, the loss function is computed based on the content of the Assistant role, representing the assistant's generated response. The overall loss function for the entire model training process is measured by the sum of the task-specific loss functions.

### EXAMPLE OF INVENTION

The proposed method in this invention has been implemented on the MultiWOZ 2.2 dataset, which is a well-known benchmark dataset for TOD systems. Specifically, the dataset consists of dialogue samples spanning seven different domains, including Restaurant, Hotel, Attraction, Taxi, Train, Hospital, and Police. The dataset is divided into 8,438 training samples and 1,000 testing samples. Inform Rate, which measures the accuracy of the virtual assistant in providing relevant entities, and Success Rate, which evaluates the system's ability to fulfill all user query requirements, are the two metrics for the evaluation. Accordingly, the proposed method in this invention, using Meta-Llama-3-8B as the LLM backbone, trained with only 10% of the training set, increased by around 7% of the Inform Rate and 5% of the Success Rate, compared with the traditional approach using a pre-trained language model with full finetuning (100% training sample dataset).

### EFFECT OF INVENTION

A significant advantage of this invention lies in the development of a TOD model that achieves high performance with a minimal amount of training samples (10% of the training set). Furthermore, the method uses LLM as the backbone with less than 10 billion parameters, which enables the scalability and extensibility for developing TOD in real-world applications.

Although the above descriptions contain many specifics, they are not intended to be a limitation of the embodiment of the invention but are intended only to illustrate some preferred execution.

1. A method of developing an end-to-end TOD system with few-shot learning comprises the following steps:
step 1: proposing an LLM-powered end-to-end TOD pipeline; with an architecture that comprises three main task components, that standardize the traditional TOD tasks such as NLU, DST, and NLG into a function-calling paradigm, which are function selection, function completion, and generate response, respectively;
step 2: fine-tuning instruction LLM for multi-task learning of function-related tasks; enhancing function-related tasks for LLMs using dialogues with instruction of function calling task;
step 3: proposing efficient training strategies, including input data normalization and a design of task-specific loss functions for a training process; an overall loss function for an entire model training process is measured by a sum of task-specific loss functions, including function selection, function completion, and generation response, respectively.
